(19) United States
(12) Patent Application Publication
(10) Pub. No.: US 2009/0102108 A1
(43) Pub. Date: Apr. 23, 2009

(54) CAM-ACTION SLEEVE PULLER

(75) Inventor: John F. Kruse, Mokena, IL (US)

Correspondence Address: INTERNATIONAL ENGINE INTELLECTUAL PROPERTY COMPANY, 4201 WINFIELD ROAD, P.O. BOX 1488, WARRENVILLE, IL, 60555, US

(73) Assignee: International Engine Intellectual Property Company, LLC, Warrenville, IL (US)

(21) Appl. No.: 11/873,468

(22) Filed: Oct. 17, 2007

(51) Int. Cl. B23Q 1/44; B23P 19/04

(52) U.S. Cl. 269/52; 29/255

(57) ABSTRACT

A tool (10) for removing a cylinder bore liner (CL) from a cylinder bore of an engine. The tool is cam-actuated and allows for exchange of certain parts for use with different liner diameters.

### FIELD OF THE INVENTION

This invention relates to a tool that is used to remove a cylindrical object, such as a cylinder liner, from a hole, such as an engine cylinder bore.

### BACKGROUND OF THE INVENTION

A typical internal combustion engine comprises a cylinder block, typically cast metal, having cylinder bores. Cylindrical metal sleeves, commonly referred to as cylinder bore liners or just cylinder liners, are fit to the cylinder bores. For any of various reasons, it may become necessary to remove one or more cylinder liners from their bores.

When cylinder liners must be removed from an engine that is installed in a motor vehicle, it is often preferable to allow the engine to remain in the vehicle and simply disassemble parts that provide access for removing the cylinders liners instead of removing the entire engine.

If it is necessary for a mechanic to work underneath an engine in order to remove a cylinder liner, he or she is potentially exposed to falling debris from the engine and adjacent components and to coolant or oil spills. That is obviously an undesirable working environment.

Ease of removal of a cylinder liner is of course desirable. Having to hammer a cylinder liner out of a bore using a hard synthetic part like a nylon rod or tube imposes impacts and stresses on parts of the human body and requires significant strength. Such impacts and stresses are undesirable as well. The task of removing cylinder liners is aggravated when a mechanic must be underneath an engine and hammer in a direction opposite the force of gravity.

Recognizing undesirable factors such as those just mentioned, the applicant has invented a tool that facilitates removal of cylinder liners from cylinder bores.

### SUMMARY OF THE INVENTION

The present invention relates to a new and improved tool, sometimes referred to as a sleeve puller, for extracting a cylinder liner from a cylinder bore by exerting a pulling force on the liner.

The tool can be used to remove a liner from a cylinder bore via the top of an engine, thereby avoiding the need for a mechanic to perform the operation from underneath the engine where he or she might be exposed to falling matter or spilling fluids, as pointed out above.

The tool also inherently provides a mechanical advantage to the person using it thereby imposing lower stresses on the body and requiring less strength.

The tool also features a construction that allows it to be used for extracting different diameter sleeves. End pieces, or feet, are pivotally and exchangeably mounted at opposite ends of a bar. By providing sets of feet of different lengths, a particular set of feet can be mounted on the bar to provide a proper diameter for extracting a particular diameter cylinder liner.

One general aspect of the present invention relates to a tool for use in extracting a cylindrical sleeve from a bore in a body.

The tool comprises a sleeve engagement part that has ends for radially overlapping a far end edge of a sleeve in a bore on opposite semi-circumferences of the sleeve and a center from which a rod extends perpendicularly. A reaction part is disposed perpendicular to the rod and has ends for radially overlapping a margin surface of the body surrounding the bore on opposite semi-circumferences of the margin surface. The reaction part also has a central clearance hole through which the rod passes.

A screw thread threads the rod to a through-hole in a shaft that is perpendicular to the rod. An actuator part that can turn on the shaft about an axis of the shaft comprises a bearing surface that extends along a cam profile relative to the axis of the shaft. When the bearing surface is placed to bear against a surface of the reaction part with the reaction part itself bearing against the margin surface of the body, and with the ends of the sleeve engagement part engaging the far end edge of the sleeve, turning of the actuator part in one sense about the axis of the shaft applies force to the rod. That force is coupled to the sleeve engagement part and causes the sleeve engagement part to pull the sleeve toward the reaction part as the cam profile moves along the reaction part with turning of the actuator part.

According to another general aspect of the invention, the sleeve engagement part has ends for radially overlapping a far end edge of the sleeve on opposite semi-circumferences of the sleeve. A rod extends perpendicularly from a center of the sleeve engagement part to a mechanism for transmitting a force through the rod to the sleeve engagement part to cause the sleeve engagement part to pull the sleeve toward the mechanism when the mechanism is actuated to extract the sleeve from the bore

The sleeve engagement part comprises a central bar. Clevis joints pivotally mount end pieces containing the ends of the sleeve engagement part on ends of the bar for swinging motion about respective axes that lie on respective chords of the bore and that are constrained to swing within a range extending from a position of radial alignment with the bar toward a segment of the length of the rod that is between the bar and the mechanism.

The clevis joints allow the end pieces to be disassembled from the bar and replaced by different end pieces.

Another general aspect of the invention relates to a method of extracting a cylindrical sleeve from a bore in a body.

The method comprises passing a sleeve engagement part of a tool through a sleeve with end pieces of the sleeve engagement part that are mounted on ends of a central bar for swinging about respective axes swung to clear the sleeve.

When the sleeve engagement part has passed far enough the sleeve for the end pieces to clear a far end edge of the sleeve, the force of gravity is allowed to swing the end pieces against respective stops to respective positions that radially overlap the far end edge of the sleeve. A mechanism that is coupled to the sleeve engagement part is actuated to pull the sleeve engagement part to a position that places the end pieces against the far end edge of the sleeve. Continuing actuation of the mechanism pulls the sleeve engagement part and begins extracting the sleeve.

The foregoing, along with further features and advantages of the invention, will be seen in the following disclosure of a presently preferred embodiment of the invention depicting the best mode contemplated at this time for carrying out the invention. This specification includes drawings, now briefly described as follows.

### BRIEF DESCRIPTION OF THE DRAWINGS

FIG. 1 is a side elevation view of a tool embodying principles of the present invention.

FIG. 2 is a partial view of the tool on a larger scale with parts of the tool in different positions from those in FIG. 1.

FIG. 3 is a partial view of a portion of the tool on a larger scale.

FIG. 4 is a view useful in understanding how the tool is used.

FIG. 5 is a diagram illustrating further use.

FIG. 6 is a view in the direction of arrows 6-6 in FIG. 5.

### DESCRIPTION OF THE PREFERRED EMBODIMENT

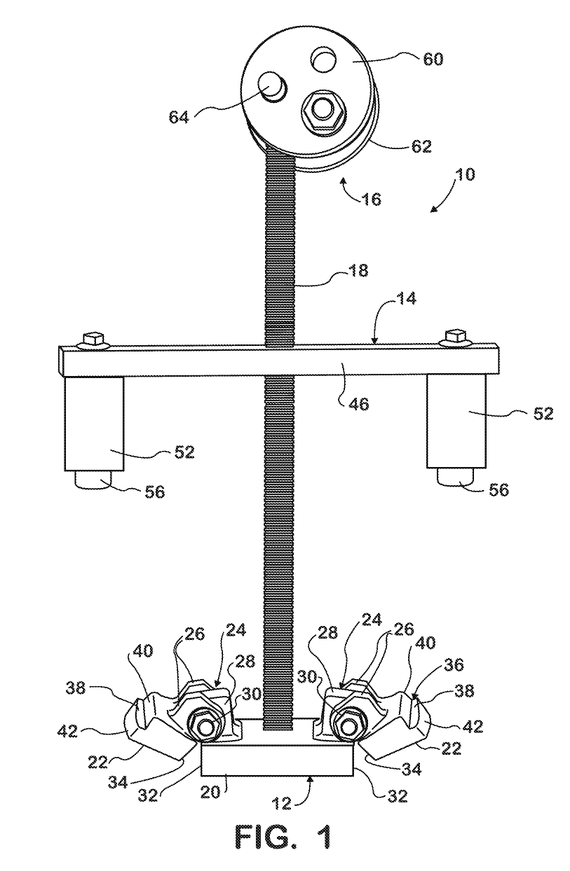

FIG. 1 shows the overall arrangement of a tool 10 that comprises a sleeve engagement part 12, a reaction part 14, and an actuator part 16, each of which is associated in a particular way with a rod 18.

Sleeve engagement part 12 is an assembly that comprises a bar 20 that is rigidly attached at its center to an end of rod 18, with the bar being perpendicular to the rod. Part 12 also comprises end pieces 22 at opposite ends of bar 20. Each end piece 22 is pivotally mounted on bar 20 by a respective clevis joint 24. Each clevis joint 24 comprises a pair of spaced apart ears 26 on piece 22 that straddle a single ear 28 on bar 20. Each clevis joint is completed by a fastener 30 that passes through aligned holes in the three ears.

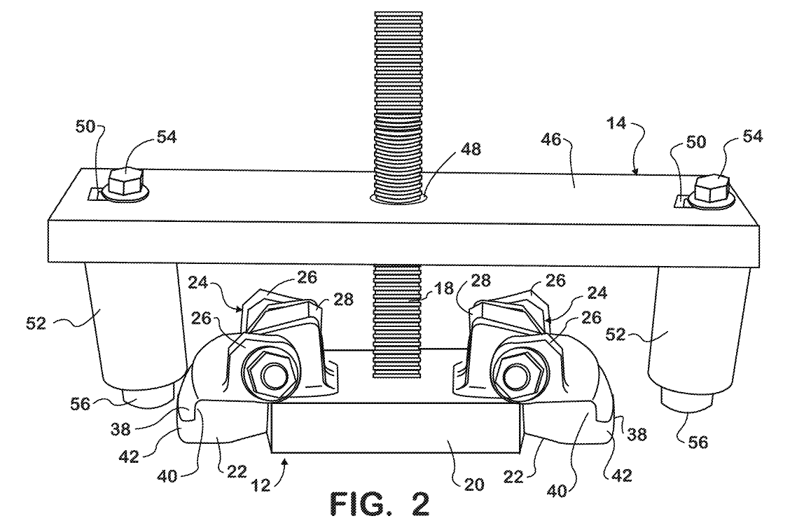

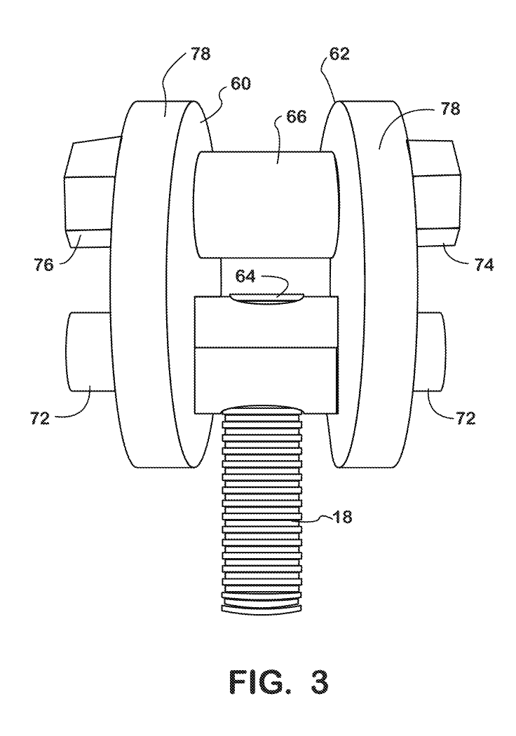

Bar 20 has flat end surfaces 32 that are parallel with rod 18. End pieces 22 have inner end surfaces 34 that are also flat. When tool 10 is in a vertically upright position, as in FIG. 1, the force of gravity acts on end pieces 22 in a manner that causes them to assume the position shown in FIG. 2, although FIG. 1 shows them swung upwardly and inwardly about the pivot axis of the respective clevis joint toward a segment of the length of rod 18 that is between sleeve engagement part 12 and reaction part 14. In the position of FIG. 2, each inner end surface 34 of end pieces 22 is abutting a respective end surface 32 of bar 20.

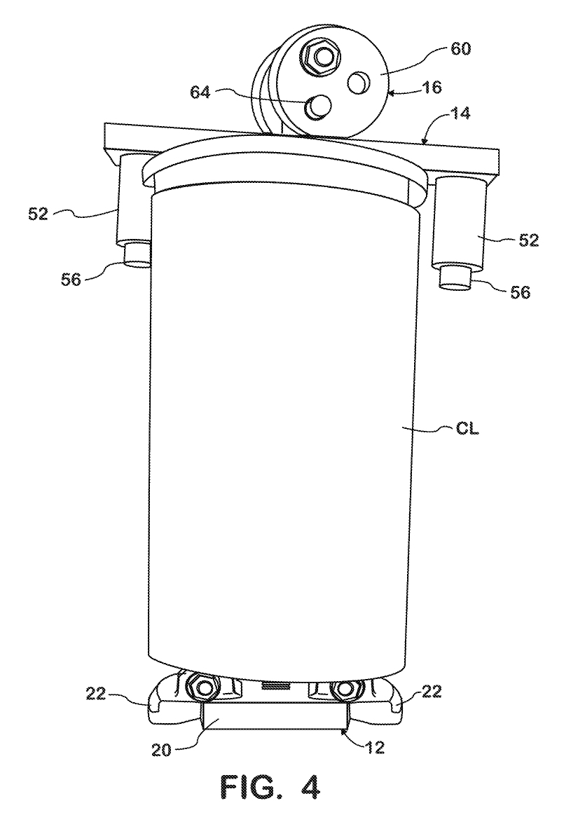

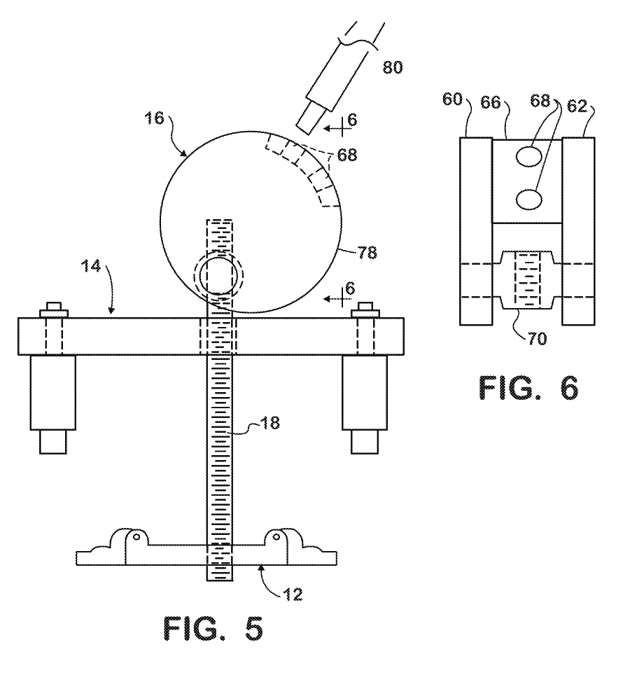

The outer ends of pieces 22 are contoured and have contoured undercuts 36 that associate with a cylinder liner (reference CL in FIG. 4) when tool 10 is used as will be eventually explained at greater length. Each undercut 36 has a flat surface 38 that faces upward in FIG. 2 and an adjoining surface 40 that is flat, but curved, and lies perpendicular to surface 38. An end surface 42 below surface 38 is also flat, but curved.

Reaction part 14 is an assembly that comprises a bar 46 at the center of which is a clearance hole 48 through which rod 18 passes. Near its ends bar 46 has through-slots 50 whose lengths parallel that of the bar. Cylindrical posts 52 are fastened to the underside of bar 46 by screws 54 that pass from the top side of the bar through through-slots 50 and are threaded into the posts. At their far ends, the posts have dowels 56.

Actuator part 16 is an assembly that comprises two circular parts 60, 62 of equal diameter disposed mutually parallel on opposite diametrical sides of rod 18 with their centers lying on a common axis. Parts 60, 62 are pivotally mounted on a stub shaft 64 such that the axis of the stub shaft is eccentrically parallel with the common axis of the two parts 60, 62. Actuator part 16 further comprises a spacer 66 that is disposed between the two parts 60, 62 at a location spaced circumferentially from stub shaft 64. Spacer 66 has a series of holes 68 in its side as shown in FIG. 6.

Stub shaft 64 has a threaded hole 70 into which rod 18 is threaded. The axis of hole 70 lies on a diameter of the larger central portion of the stub shaft that is between the smaller diameter ends 72 that are received in holes in parts 60, 62. Spacer 66 also has a through-hole that aligns with through-holes in parts 60, 62. The shank of a headed bolt 74 passes through the three aligned though-holes, and a nut 76 that is tightened onto the bolt shank forces parts 60, 62 against ends of spacer 66 thereby holding parts 60, 62, 64, and 66 in assembled relationship.

Because of the eccentricity of the stub shaft axis to the common diameter of the two circular parts 60, 62, the circular perimeters 78 of parts 60, 62 form a cam surface with respect to the stub shaft axis.

FIG. 4 suggests how tool 10 is used. Sleeve engagement part 12 is inserted into the open upper end of an engine cylinder whose liner CL is to be removed. As end pieces 22 abut the top edge of liner CL, they swing to a position such as in FIG. 1 to clear the liner. When the tool has been inserted far enough for end pieces 22 to clear a bottom end edge of the liner, the force of gravity causes them to swing to the position shown in FIG. 4 where surfaces 34 abut surfaces 32, and surfaces 38 radially overlap the bottom end edge of the liner.

Reaction part 14 slides down on rod 18 to a position where dowels 56 fit into bolt holes in a surface of the cylinder block surrounding the cylinder bore. Actuator part 16 is then used to begin extracting liner CL from the bore.

The end of a handle 80 shown in FIG. 6 is inserted one of the holes 68 and used as a lever to begin turning parts 60, 62 clockwise about the axis of stub shaft 64. The perimeters 78 of parts 60, 62 are forced against the top surface of bar 46 forcing reaction part 14 downwardly against the cylinder block. Because the reaction part cannot move downward, the movement of perimeters 78 across the top surface of bar 46 acts to cam stub shaft 64 upward. That motion is transmitted by rod 18 to sleeve engagement part 12, causing end pieces to force liner CL upward toward reaction part 14 thereby freeing the liner and leading to its extraction from the bore.

While a presently preferred embodiment of the invention has been illustrated and described, it should be appreciated that principles of the invention apply to all embodiments falling within the scope of the following claims.

What is claimed is:

1. A tool for use in extracting a cylindrical sleeve from a bore in a body, the tool comprising:
a) a sleeve engagement part that has ends for radially overlapping a far end edge of a sleeve in a bore on opposite semi-circumferences of the sleeve and a center from which a rod extends perpendicularly, b) a reaction part that is disposed perpendicular to the rod, that has ends for radially overlapping a margin surface of the body surrounding the bore on opposite semi-circumferences of the margin surface, and that has a central clearance hole through which the rod passes, c) a screw thread that threads the rod to a through-hole in a shaft that is perpendicular to the rod, and d) an actuator part that can turn on the shaft about an axis of the shaft and that comprises a bearing surface that extends along a cam profile relative to the axis of the shaft and that when placed to bear against the reaction part with the reaction part bearing against the margin surface of the body and with the ends of the sleeve engagement part engaging the far end edge of the sleeve, transmits a force via the rod that is coupled to the sleeve engagement part to cause the sleeve engagement part to pull the sleeve toward the reaction part as the actuator part is being turned in one sense about the axis of the shaft.

2. A tool as set forth in claim 1 in which the sleeve engagement part comprises a bar that lies on a diameter of the bore and that has sleeve engagement pieces that are pivotally mounted on the bar at opposite diametrical ends of the bar for swinging motion about respective axes that lie on respective chords of the bore and that are constrained to swing within a range extending from a position of radial alignment with the bar toward a segment of the length of the rod that is between the bar and the reaction part.

3. A tool as set forth in claim 2 in which the sleeve engagement pieces comprise contoured undercuts for locating a distal end of each sleeve engagement piece to a segment of an end edge of the sleeve and an adjoining portion of an inside wall of the sleeve.

4. A tool as set forth in claim 2 in which the pivotal mounting of each sleeve engagement piece to the bar comprises a clevis joint and fastener that allow each sleeve engagement piece to be disassembled from the bar and replaced by a different sleeve engagement piece.

5. A tool as set forth in claim 2 in which the position of radial alignment of each sleeve engagement piece with the bar is defined by abutment of a face of the respective sleeve engagement piece with a face at an end of the bar.

6. A tool as set forth in claim 1 in which the rod is rigidly affixed to the sleeve engagement part.

7. A tool as set forth in claim 1 in which the reaction part comprises a bar that lies on a diameter of the bore and dowels that extend from ends of the bar parallel to the rod for locating the bar in holes in the margin surface of the body.

8. A tool as set forth in claim 1 in which the actuator part comprises an assembly of two circular parts of equal diameter disposed mutually parallel on opposite diametrical sides of the rod with their centers lying on a common axis and with the two circular parts being pivotally mounted on the shaft such that the axis of the shaft is eccentrically parallel with the common axis of the two circular parts.

9. A tool as set forth in claim 8 in which the actuator part assembly further comprises a spacer part that is disposed between the two circular parts at a location spaced circumferentially from the shaft and that has one or more receptacles into which an end of a handle can be inserted to enable the handle to turn the actuator part about the axis of the shaft.

10. A tool a) that is used for extracting a cylindrical sleeve from a bore in a body, b) that has a sleeve engagement part having ends for radially overlapping a far end edge of the sleeve on opposite semi-circumferences of the sleeve and a center from which a rod extends perpendicularly to a mechanism for transmitting a force through the rod to the sleeve engagement part to cause the sleeve engagement part to pull the sleeve toward the mechanism when the mechanism is actuated to extract the sleeve, and c) that has a bar containing the center of the sleeve engagement part and clevis joints pivotally mounting end pieces containing the ends of the sleeve engagement part on the bar for swinging motion about respective axes that lie on respective chords of the bore and that are constrained to swing within a range extending from a position of radial alignment with the bar toward a segment of the length of the rod that is between the bar and the mechanism, each clevis joint allowing each end piece to be disassembled from the bar and replaced by a different end piece.

11. A tool as set forth in claim 10 in which the end pieces comprise contoured undercuts for locating a distal end of each end piece to a segment of an end edge of the sleeve and an adjoining portion of an inside wall of the sleeve.

12. A tool as set forth in claim 10 in which the position of radial alignment of each end piece with the bar is defined by abutment of a face of the respective end piece with a face at an end of the bar.

13. A method of extracting a cylindrical sleeve from a bore in a body, the method comprising:
passing a sleeve engagement part of a tool through a sleeve with end pieces of the sleeve engagement part that are mounted on ends of a central bar for swinging about respective axes swung to clear the sleeve, and when the sleeve engagement part has passed far enough the sleeve for the end pieces to clear a far end edge of the sleeve, allowing the force of gravity to swing the end pieces against respective stops to respective positions that radially overlap the far end edge of the sleeve, and actuating a mechanism that is coupled to the sleeve engagement part to pull the sleeve engagement part to a position that places the end pieces against the far end edge of the sleeve and then continuing to actuate the mechanism to further pull the sleeve engagement part and begin extracting the sleeve.

14. A method as set forth in claim 13 in which the step of allowing the force of gravity to swing the end pieces against respective stops to respective positions that radially overlap the far end edge of the sleeve comprises allowing the force of gravity to swing the end pieces against respective ends of the central bar that define the respective stops.

15. A method as set forth in claim 13 in which the step of actuating a mechanism that is coupled to the sleeve engagement part to pull the sleeve engagement part to a position that places the end pieces against the far end edge of the sleeve and then continuing to actuate the mechanism to further pull the sleeve engagement part and begin extracting the sleeve comprises turning a cam against a reaction part that has ends radially overlapping and bearing against a margin surface of a body surrounding the bore on opposite semi-circumferences of the margin surface to pull the sleeve engagement part via a rod that is coupled to the cam and extends through the sleeve to the sleeve engagement part.
